(19) United States
(12) Patent Application Publication
(10) Pub. No.: US 2010/0008086 A1
(43) Pub. Date: Jan. 14, 2010

(54) LED white-light devices for direct form, fit, and function replacement of existing incandescent and compact fluorescent lighting devices

(76) Inventor: Troy R. Broitzman, Wayzata, MN (US)

Correspondence Address: Troy Richard Broitzman, 2195 Daniels St., PO Box 907, Long Lake, MN, 55356-0907, US

(21) Appl. No.: 12/459,876

(22) Filed: Jul. 9, 2009

Related U.S. Application Data
(60) Provisional application No. 61/134,367, filed on Jul. 9, 2008.

(51) Int. Cl. F21K 7/00; F21V 13/02; F21V 29/00

(52) U.S. Cl. 362/231; 362/227; 362/235; 362/234

(57) ABSTRACT

A white light LED-based lighting device configured for direct form, fit, and function replacement of existing incandescent and compact fluorescent devices is provided. The white light LED-based lighting device comprises a group of solid state light emitting diodes, electronics to activate the light emitting diodes, and an encapsulating housing configured for direct form, fit, and function replacement of existing incandescent and compact fluorescent devices.

### CROSS-REFERENCE TO RELATED APPLICATIONS

The present application claims the benefit of and priority to U.S. Provisional Application Ser. No. 61/134,367, filed Jul. 9, 2008 the entire content of which being incorporated herein by reference.

### FIELD OF THE INVENTION

The present invention is directed generally to lighting devices, and more particularly to a white light LED-based lighting devices configured for direct form, fit, and function replacement of existing incandescent and compact fluorescent lighting devices.

### BACKGROUND

Energy conservation, in all its varied forms, has become a national priority of the United States as well as the rest of the world, from both the practical point of view of limited natural resources and recently as a security issue to reduce our dependence on foreign oil. A large proportion (some estimates are as high as one third) of the electricity used in residential homes in the United States each year goes to lighting. The percentage is much higher for businesses, street lights, amongst other varied items. Accordingly, there is an ongoing need to provide lighting, which is more energy efficient. It is well known that incandescent light bulbs are very energy inefficient light sources—about ninety percent of the electricity they consume is released as heat rather than light. This heat adds to the cooling load of a system during cooling season. In heating season the cost per BTU of heat that the lights give off is typically more expensive than the cost per BTU of the main heat source. The heat that is given off by the lighting also can cause “over shooting” of the desired temperature which waists energy and makes the space feel uncomfortable. Fluorescent light bulbs are more efficient than incandescent light bulbs (by a factor of about four) but are still quite inefficient as compared to solid state light emitters, such as light emitting diodes (LED's).

In addition, as compared to the normal lifetimes of solid state light emitters, incandescent light bulbs have relatively short lifetimes, i.e., typically in the range of 750 to 2000 hours. Fluorescent bulbs have longer lifetimes (e.g., 8,000 to 20,000 hours), but provide less favorable color reproduction. In dramatic comparison, the lifetime of light emitting diodes, for example, can generally be measured in decades (approximately 100,000 hrs or more).

One established method of comparing the output of different light generating sources has been coined color reproduction. Color reproduction is typically given numerical values using the so-called Color Rendering Index (CRI). CRI is a relative measurement of how the color rendition of an illumination system compares to that of a blackbody radiator, i.e., it is a relative measure of the shift in surface color of an object when lit by a particular lamp. The CRI equals 100 if a set of test colors being illuminated by an illumination system are the same as the results as being irradiated by a blackbody radiator. Daylight has the highest CRI (100), with incandescent bulbs being relatively close (about 95), and fluorescent lighting being less accurate (70 to 85). Certain types of specialized lighting have relatively low CRI's (e.g., mercury vapor or sodium, both as low as about 40 or even lower). Sodium lights are used, e.g., to light highways and surface streets. Driver response time, however, significantly decreases with lower CRI values (for any given brightness, legibility decreases with lower CRI).

A practical issue faced by conventional lighting systems is the need to periodically replace the lighting devices (e.g., light bulbs, etc.). Such issues are particularly pronounced where access is difficult (e.g., vaulted ceilings, bridges, high buildings, traffic tunnels) and/or where change-out costs are extremely high. The typical lifetime of conventional fixtures is about 20 years, corresponding to a light-producing device usage of at least about 44,000 hours (based on a typical usage of 6 hours per day for 20 years). In contrast light-producing device lifetimes are typically much shorter, thus creating the need for periodic change-outs. The potential number of residential homes that may be candidates for these periodic change-outs of the traditional incandescent lighting systems, including base fixtures and lamps themselves, may be extremely large and represent an attractive commercial enterprise. For example, in the United States alone new residential home construction has average approximately 1.5 million dwellings per year over the last 30 years running. Even neglecting older homes built before 1978, this represents at least 45 million residential dwellings that are candidates for potential upgrades to more energy efficient LED-based lighting systems.

Accordingly, for these and other reasons, efforts have been ongoing to develop ways by which solid state light emitters can be used in place of incandescent lights, fluorescent lights and other light-generating devices in a wide variety of applications. In addition, where solid state light emitters are already being used, efforts are ongoing to provide solid state light emitter-containing devices which are improved energy efficiency, color rendering index (CRI), contrast, and useful lifetime.

Light emitting diodes are well-known semiconductor devices that convert electrical current into light. A wide variety of light emitting diodes are used in increasingly diverse fields for an ever-expanding range of purposes. More specifically, light emitting diodes are semiconducting devices that emit light (ultraviolet, visible, or infrared) when an electrical potential difference is applied across a p-n junction structure. There are a number of well-known ways to make light emitting diodes and many associated structures, and the present invention can employ any such manufacturing technique.

The commonly recognized and commercially available light emitting diodes that are sold, for example, in electronics stores typically represents a “packaged” device made up of a number of parts. These packaged devices typically include a semiconductor-based light emitting diode and a means to encapsulate the light emitting diode. As is well known, a light emitting diode produces light by exciting electrons across the band gap between a conduction band and a valence band of a semiconductor active (light-emitting) layer. The electron transition generates light at a wavelength that depends on the band-gap energy difference. Thus, the color of the light (usually expressed in terms of its wavelength) emitted by a light emitting diode depends on the semiconductor materials of the active layers of the light emitting diode.

Although the development of solid state light emitters, e.g., light emitting diodes, has in many ways revolutionized the lighting industry, some of the characteristics of solid state light emitters have presented challenges, some of which have not yet been fully met. For example, the emission spectrum of any particular light emitting diode is typically concentrated around a single wavelength (as dictated by the light emitting diode's composition and structure), which is desirable for some applications, but not desirable for others, e.g., for providing lighting, given that such an emission spectrum typically provides a very low CRI.

Because light that is perceived as white is necessarily a blend of light of two or more colors (or wavelengths), no single light emitting diode can produce white light. “White light” emitting devices have been produced which have a light emitting diode structure comprising individual red, green and blue light emitting diodes mounted on a common substrate. Other “white light” emitting devices have been produced which include a light emitting diode which generates blue light and a luminescent material (e.g., a phosphor) that emits yellow light in response to excitation by the blue LED output, whereby the blue and the yellow light, when appropriately mixed, produce light that is perceived as white light. A wide variety of luminescent materials are well-known and available to persons of skill in the art. For example, a phosphor is a luminescent material that emits a responsive radiation (typically visible light) when excited by a source of exciting radiation. In many instances, the responsive radiation has a wavelength, which is different, typically longer, from the wavelength of the exciting radiation. Other examples of luminescent materials include day glow tapes and inks, which glow in the visible spectrum upon illumination with ultraviolet light. Luminescent materials can be categorized as being down-converting, i.e., a material which converts photons to a lower energy level (longer wavelength) or up-converting, i.e., a material which converts photons to a higher energy level (shorter wavelength). Inclusion of luminescent materials in LED devices has typically been accomplished by adding the luminescent materials to a clear plastic encapsulating material (e.g., epoxy-based or silicone-based material).

As noted above, “white LED lights” (i.e., lights which are perceived as being white or near-white) have been investigated as potential replacements for white light incandescent lamps. A representative example of a white LED lamp includes a package of a blue light emitting diode chip, made of gallium nitride (GaN), coated with a phosphor such as Yttrium Aluminum Garnet (YAG). In such an LED lamp, the blue light emitting diode chip produces a blue emission and the phosphor produces yellow fluorescence on adsorbing that emission. For instance, in some designs, white light emitting diodes are fabricated by forming a ceramic phosphor layer on the output surface of a blue light-emitting semiconductor light emitting diode. Part of the blue rays emitted from the light emitting diode pass through the phosphor, while part of the blue rays emitted from the light emitting diode chip are absorbed by the phosphor, which becomes excited and emits a yellow ray. The part of the blue light emitted by the light emitting diode, which is transmitted through the phosphor, is mixed with the yellow light emitted by the phosphor. The viewer perceives the mixture of blue and yellow light as white light.

In another type of LED lamp, a light emitting diode chip that emits an ultraviolet ray is combined with phosphor materials that produce red (R), green (G) and blue (B) light rays. In such an “RGB LED lamp”, the ultraviolet rays that have been radiated from the light emitting diode excites the phosphor, causing the phosphor to emit red, green and blue light rays which, when mixed, are perceived by the human eye as white light. Consequently, white light can also be obtained as a mixture of these light rays.

Designs have been realized in which existing LED's and other electronics are assembled into an integrated housing fixture. In such designs, an LED or plurality of LED's are mounted on a circuit board encapsulated within the housing fixture, and a heat sink is typically mounted to the exterior surface of housing fixture to dissipate heat generated from within the device, the heat being generated by inefficient AC-to DC conversion from with the device. Although devices of this type can generate white light by any of the means described above, their external geometry does not permit direct form, fit, and function replacement of existing incandescent lighting systems currently installed in residential homes. For example, one such prior art device is described in the LED Lighting Fixtures Inc. catalog as part number LR6. The LR6 embodiment includes an encapsulated LED structure with an external heat sink assembly integrated as part of a thermal management system. The necessity of an external heat sink assembly in conjunction with an integrated thermal management system adds significant cost to the device as compared to equivalent light output off-the-shelf incandescent devices. In addition, the incorporation of the external heat sink assembly adds significant weight to the device as well as yields an overall external geometry to the lamp which is cylindrical in nature, not at all similar to the familiar incandescent lamps, which in itself may be an impediment to market acceptance to the average home owner envisioning a direct form, fit, and function swap-out.

Given this, there is a need for a “white light” Led device capable of direct form, fit, and function replacement of existing incandescent and compact fluorescent devices which can be installed directly by the homeowner without the need of unwanted masonry work and without the additional cost of a licensed technician to perform such an installation.

### SUMMARY OF THE INVENTION

Generally, the present invention is directed to lighting devices, and more particularly to white light LED-based lighting devices configured for direct form, fit, and function replacement of existing incandescent and compact fluorescent devices.

One embodiment of the present invention describes a lighting device for generating diffuse white light comprising a group of solid state light emitters, electronics to activate the solid state light emitters by converting 120 volt 60 cycles per second alternating current to a steady state voltage, direct current, and an encapsulating housing enclosing the solid state light emitters and the activating electronics with a shape and form factor substantially equivalent to the American National Standards Institute (ANSI) R20 lighting device structure.

An alternative embodiment of the present invention describes a lighting device for generating diffuse white light comprising a group of solid state light 20 emitters, electronics to activate the solid state light emitters by converting 120 volt 60 cycles per second alternating current to a steady state voltage, direct current, and an encapsulating housing enclosing the solid state light emitters and the activating electronics with a shape and form factor substantially equivalent to the American National Standards Institute (ANSI) R20 lighting device structure.

Another embodiment of the present invention describes a lighting device for generating diffuse white light comprising a group of solid state light emitters, electronics to activate the solid state light emitters by converting 120 volt 60 cycles per second alternating current to a steady state voltage, direct current, and an encapsulating housing enclosing the solid state light emitters and the activating electronics with a shape and form factor substantially equivalent to the American National Standards Institute (ANSI) R40 lighting device structure.

Another embodiment of the present invention describes a lighting device for generating diffuse white light comprising a group of solid state light emitters, said group including light emitting diodes energized by a direct current (DC) voltage, a housing configured to supply a direct current (DC) voltage to the base of the lighting device, electronics to activate the solid state light emitters, wherein the electronics may be configured as a DC-to-DC converter to apply the appropriate DC voltage(s) and drive currents to the DC driven LEDs, and an encapsulating housing enclosing the solid state light emitters and the activating electronics with a shape and form factor substantially equivalent to the American National Standards Institute (ANSI) R20 lighting device structure.

Another embodiment of the present invention describes a lighting device for generating diffuse white light comprising a group of solid state light emitters, said group including light emitting diodes energized by a direct current (DC) voltage, a housing configured to supply a direct current (DC) voltage to the base of the lighting device, electronics to activate the solid state light emitters, wherein the electronics may be configured as a DC-to-DC converter to apply the appropriate DC voltage(s) and drive currents to the DC driven LEDs, and an encapsulating housing enclosing the solid state light emitters and the activating electronics with a shape and form factor substantially equivalent to the American National Standards Institute (ANSI) R30 lighting device structure.

Another embodiment of the present invention describes a lighting device for generating diffuse white light comprising a group of solid state light emitters, said group including light emitting diodes energized by a direct current (DC) voltage, a housing configured to supply a direct current (DC) voltage to the base of the lighting device, electronics to activate the solid state light emitters, wherein the electronics may be configured as a DC-to-DC converter to apply the appropriate DC voltage(s) and drive currents to the DC driven LEDs, and an encapsulating housing enclosing the solid state light emitters and the activating electronics with a shape and form factor substantially equivalent to the American National Standards Institute (ANSI) R40 lighting device structure.

Another embodiment of the present invention describes a lighting device for generating diffuse white light comprising a group of solid state light emitters, said group including light emitting diodes energized by an alternating current (AC) drive voltage, a housing configured to supply a 120 volt AC (60 Hertz) input signal to the base of the lighting device, electronics to activate the solid state light emitters, wherein the electronics may be configured as a AC-to-AC converter to apply the appropriate AC voltage(s) and drive currents to the AC driven LEDs, and an encapsulating housing enclosing the solid state light emitters and the activating electronics with a shape and form factor substantially equivalent to the American National Standards Institute (ANSI) R20 lighting device structure.

Another embodiment of the present invention describes a lighting device for generating diffuse white light comprising a group of solid state light emitters, said group including light emitting diodes energized by an alternating current (AC) drive voltage, a housing configured to supply a 120 volt AC (60 Hertz) input signal to the base of the lighting device, electronics to activate the solid state light emitters, wherein the electronics may be configured as a AC-to-AC converter to apply the appropriate AC voltage(s) and drive currents to the AC driven LEDs, and an encapsulating housing enclosing the solid state light emitters and the activating electronics with a shape and form factor substantially equivalent to the American National Standards Institute (ANSI) R30 lighting device structure.

Another embodiment of the present invention describes a lighting device for generating diffuse white light comprising a group of solid state light emitters, said group including light emitting diodes energized by an alternating current (AC) drive voltage, a housing configured to supply a 120 volt AC (60 Hertz) input signal to the base of the lighting device, electronics to activate the solid state light emitters, wherein the electronics may be configured as a AC-to-AC converter to apply the appropriate AC voltage(s) and drive currents to the AC driven LEDs, and an encapsulating housing enclosing the solid state light emitters and the activating electronics with a shape and form factor substantially equivalent to the American National Standards Institute (ANSI) R40 lighting device structure.

Another embodiment of the present invention describes a lighting device for generating diffuse white light comprising a first group of solid state light emitters, said first group including light emitting diodes energized by an alternating current (AC) drive voltage, a second group of solid state light emitters, said second group including light emitting diodes energized by an direct current (DC) drive voltage, a housing configured to supply a 120 volt AC (60 Hertz) input signal to the base of the lighting device, electronics to activate the solid state light emitters, wherein one channel of the electronics may be configured as a AC-to-AC converter to apply the appropriate AC voltage(s) and drive currents to the AC driven LEDs, a second channel of the electronics to activate the solid state light emitters, wherein said second channel of the electronics may be configured as a AC-to-DC converter to apply the appropriate DC voltage(s) and drive currents to the DC driven LEDs, and an encapsulating housing enclosing the solid state light emitters and the activating electronics with a shape and form factor substantially equivalent to the American National Standards Institute (ANSI) R20 lighting device structure.

Another embodiment of the present invention describes a lighting device for generating diffuse white light comprising a first group of solid state light emitters, said first group including light emitting diodes energized by an alternating current (AC) drive voltage, a second group of solid state light emitters, said second group including light emitting diodes energized by an direct current (DC) drive voltage, a housing configured to supply a 120 volt AC (60 Hertz) input signal to the base of the lighting device, electronics to activate the solid state light emitters, wherein one channel of the electronics may be configured as a AC-to-AC converter to apply the appropriate AC voltage(s) and drive currents to the AC driven LEDs, a second channel of the electronics to activate the solid state light emitters, wherein said second channel of the electronics may be configured as a AC-to-DC converter to apply the appropriate DC voltage(s) and drive currents to the DC driven LEDs, and an encapsulating housing enclosing the solid state light emitters and the activating electronics with a shape and form factor substantially equivalent to the American National Standards Institute (ANSI) R30 lighting device structure.

Another embodiment of the present invention describes a lighting device for generating diffuse white light comprising a first group of solid state light emitters, said first group including light emitting diodes energized by an alternating current (AC) drive voltage, a second group of solid state light emitters, said second group including light emitting diodes energized by an direct current (DC) drive voltage, a housing configured to supply a 120 volt AC (60 Hertz) input signal to the base of the lighting device, electronics to activate the solid state light emitters, wherein one channel of the electronics may be configured as a AC-to-AC converter to apply the appropriate AC voltage(s) and drive currents to the AC driven LEDs, a second channel of the electronics to activate the solid state light emitters, wherein said second channel of the electronics may be configured as a AC-to-DC converter to apply the appropriate DC voltage(s) and drive currents to the DC driven LEDs, and an encapsulating housing enclosing the solid state light emitters and the activating electronics with a shape and form factor substantially equivalent to the American National Standards Institute (ANSI) R40 lighting device structure.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1A shows a schematic representation of one embodiment of the present invention depicting a white light LED device configured for direct form, fit, and function replacement of existing incandescent devices categorized by the American National Standards Institute (ANSI) as having part numbers R20, R30, and R40.

FIG. 1B shows a schematic representation of the prior art incandescent lighting devices highlighting the one-to-one matching external geometry of the prior art versus the embodiment of the present invention as depicted in FIG. 1A.

FIG. 2A depicts the “R” series white light LED device shown in FIG. 1A highlighting a modular insert element.

FIG. 2B depicts a breakout of the modular insert element shown in FIG. 2A.

FIG. 3A shows a schematic representation of one embodiment of the present invention depicting a white light LED device configured for direct form, fit, and function replacement of existing incandescent devices categorized by the American National Standards Institute (ANSI) as having part numbers BR25, BR30, and BR40.

FIG. 3B depicts a breakout of the modular insert element shown in FIG. 3A.

FIG. 4A shows a schematic representation of one embodiment of the present invention depicting a white light LED device configured for direct form, fit, and function replacement of existing incandescent devices categorized by the American National Standards Institute (ANSI) as having part numbers PAR15, PAR30, and PAR305.

FIG. 4B depicts a breakout of the modular insert element shown in FIG. 4A.

FIG. 5A shows a schematic representation of one embodiment of the present invention depicting a white light LED device configured for direct form, fit, and function replacement of existing incandescent devices categorized by the American National Standards Institute (ANSI) as having part numbers A15, A19, A21, and A23

FIG. 5B depicts a breakout of the modular insert element shown in FIG. 5A.

FIG. 6A shows a schematic representation of one embodiment of the present invention depicting a white light LED device configured for direct form, fit, and function replacement of existing incandescent devices categorized by the American National Standards Institute (ANSI) as having part numbers B10½ and B13.

FIG. 6B depicts a breakout of the modular insert element shown in FIG. 6A.

FIG. 7 depicts a white light LED device in accordance with the present invention with a shape and form factor substantially equivalent to the “R” series device shown in FIG. 1A with air vents placed circumferentially around the neck of the encapsulating housing.

FIG. 8 depicts a white light LED device in accordance with the present invention with a shape and form factor substantially equivalent to the “R” series device shown in FIG. 1A with heat transfer elements placed circumferentially around the neck of the encapsulating housing.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

In general, the present invention is directed to lighting systems, and more particularly to an LED-based white light lighting system configured for direct form, fit, and function replacement of existing incandescent and compact fluorescent lighting devices.

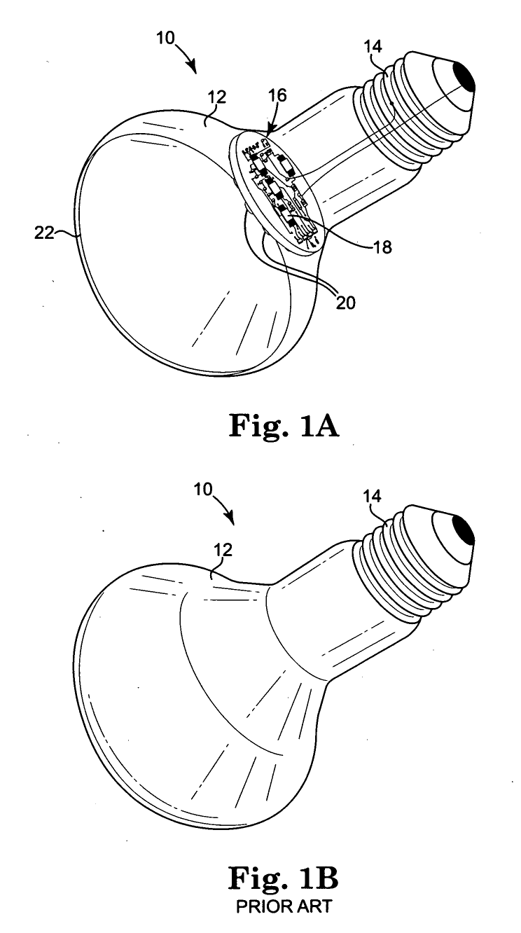

One embodiment of a white light LED device 10 in accordance with the present invention is depicted schematically in FIG. 1A. Incandescent light bulb devices with the shape and form factor depicted in FIG. 1A have generally been categorized by the American National Standards Institute (ANSI) as having part numbers R20, R30, and R40, the difference being their height, increasing with higher numerical designation. Alternative incandescent devices have been designed with a similar, but not identical, shape and form factor incorporating a slight bulge in their base section and have been designated by ANSI with a “B” prefix to highlight this feature. For example, the B40 incandescent light bulb has a similar height as its' R40 counterpart. FIG. 1A of the present invention is intended to represent the entire family of incandescent light bulbs with the “R” designation including, but not limited to, those having part numbers R20, R30, and R40.

As shown in FIG. 1A, circuit board 16 may be securely mounted within encapsulating housing 12. Encapsulating housing 12 may consist of a similar shape and form factor currently in use for standard incandescent lighting devices as depicted in FIG. 1B, also generally categorized as having a part number R20, R30, or R40. Encapsulating housing 12 may be comprised of a glass, ceramic, plastic or polymer-based material and may also include a reflective material on its inboard lateral surface and its' end-face 22 may be treated by any of a number of techniques (e.g., sand blasting) which give it a diffusing property to light emanating from the end-face of the white light LED device 10. Encapsulating housing 12 may also include air vents and heat-sinking components to conduct or transfer outwardly heat generated from within the white light LED device 10. Circuit board 16 may have individual electronic and optical components 18 mounted to its surface, which may include LED device structures which are designed to be energized by an alternating (AC) or direct current (DC) voltage. In one embodiment of the present invention, circuit board 16 may include the necessary electronic components to convert the standard 120 volt AC (60 Hertz) signal to a direct current (DC) voltage appropriate for direct current driven LED's mounted on circuit board 16

To generate white light, circuit board 16 may have individual red, green, and blue DC driven LEDs mounted in sufficiently close proximity such that their respective light outputs are spatially mixed and directed towards diffusing surface 22. Diffusing surface 22 may consist of a frosted or opal like material such that the light emanating from diffusing surface 22 appears uniformly distributed over the surface with no apparent bright spots. Alternatively, circuit board 16 may have one or more DC driven ultraviolet LEDs that emit ultraviolet rays which when absorbed by phosphor materials 20 produce red (R), green (G) and blue (B) light rays. In such an “RGB LED lamp”, the red, green and blue light rays which, when mixed, are perceived by the human eye as white light.

In an alternative embodiment of the present invention, mounting threads 14 may securely mate with a housing (not shown in FIG. 1A) configured to supply a direct current (DC) voltage to white light LED device 10. In this configuration, circuit board 16 may be configured as a DC-to-DC converter to apply the appropriate DC voltage(s) and drive currents to the DC driven LEDs mounted thereon.

In another embodiment of the present invention, the LED devices mounted on circuit board 16 may be compatible with an alternating current (AC) drive voltage. In this configuration, circuit board 16 may be configured to accept a 120 volt AC (60 Hertz) input signal and convert that signal to an AC signal appropriate for the individual LEDs mounted thereon.

In yet another embodiment of the present invention, the LED devices mounted on circuit board 16 may be a mixture of some LEDs compatible with a direct current (DC) drive voltage and other LED devices designed to be driven by an alternating current (AC) drive voltage. In this configuration, circuit board 16 may be configured to supply both the appropriate AC and DC drive voltages to the respective AC and DC LED devices.

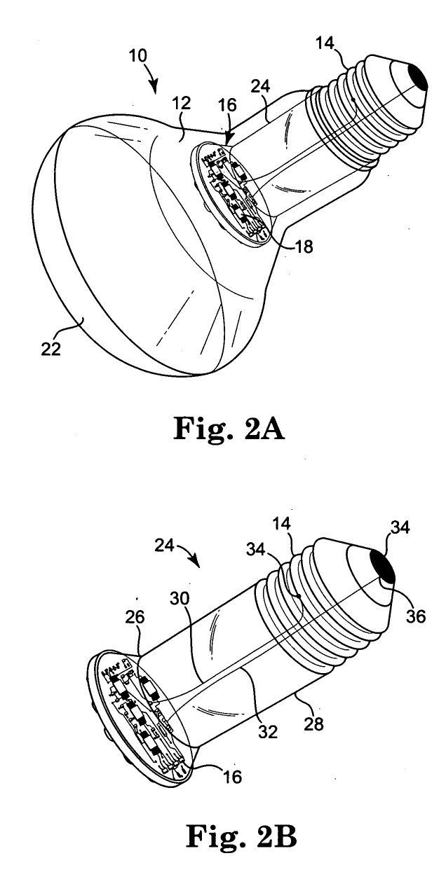

FIG. 2A depicts the “R” series white light LED device 10 shown in FIG. 1A highlighting modular insert element 24. Modular insert element 24, shown separately in FIG. 2B, may have circuit board 16 adhered directly to the end-face 26 of threaded housing element 28. Threaded housing element 28 may be comprised of a plastic, epoxy-like, or polymer-based material and may be a solid cylindrical element with metal overlay mounting threads 14. Electrical leads 30 and 32 may be embedded within threaded housing element 28 with electrical lead 30 connected to metal overlay mounting threads 14 at connection 34 and electrical lead 32 connected to metal cap 34 at connection 36. In this configuration, during assembly of white light LED device 10, modular insert element 24 may be inserted into encapsulating housing 12 (see FIG. 1A) and secured thereto prior to adhering diffusing surface 22 (again, see FIG. 1A) to encapsulating housing 12 as a final assembly step.

The present invention contemplates modifications to the above configuration depicted in FIGS. 2A and 2B including, but not limited to:
1) the threaded housing element 28 may be a thin or thick-walled cylindrical annulus (i.e., with central air gap region) with electrical leads 30 and 32 traversing within the central air gap region enroute to connection points 34 and 36 respectively.
2) the diameter of circuit board 16 may be smaller than that depicted in FIGS. 2A and 2B thereby allowing circuit board 16 to be located closer to mounting threads 14.
3) All of the electrical and optical components 18 shown in FIG. 2A may be mounted on the side of circuit board 16 nearest the diffusing surface 22.
4) With all of the electrical and optical components 18 shown in FIG. 2A mounted on the side of circuit board 16 nearest the diffusing surface 22, circuit board 16 may be in direct physical contact with a heat sinking substrate material adhered to its' surface nearest the mounting threads 14.
5) The heat sinking substrate material described in 4 above may be a thermo-electric cooling device.
6) A diffusing element may be attached directly to the solid state light emitters.
7) The diffusing element attached directly to the solid state light emitters may be a lens.
8) The diffusing element attached directly to the solid state light emitters may be a lens with a negative focal length.
9) The diffusing element attached directly to the solid state light emitters may be comprised of an opal-like material.

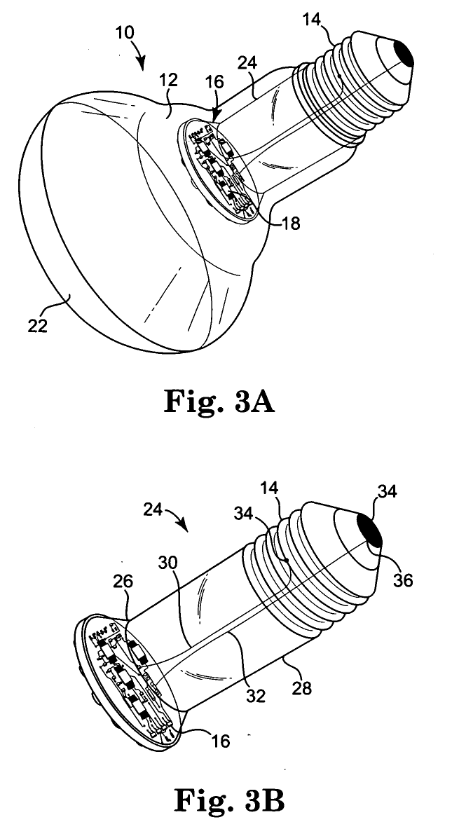

FIG. 3A depicts the “BR” configuration of a white light LED device 10 in accordance with the present invention highlighting modular insert element 24. The “BR” series is most easily recognized by the slight bulge in the region surrounding the threaded housing element 28 as compared to the “R” series depicted in FIG. 2A. Incandescent light bulb devices with the shape and form factor depicted in FIG. 3A have generally been categorized by the American National Standards Institute (ANSI) as having part numbers BR25, BR30, and BR40, the difference being their height, increasing with higher numerical designation. In one embodiment of the present invention, modular insert element 24 shown in FIG. 3B may be substantially equivalent, i.e., interchangeable with, to that shown in FIG. 2B thereby allowing the modular insert element 24 to be a common module for both the “R” and “BR” series devices.

Modular insert element 24, shown separately in FIG. 3B, may have circuit board 16 adhered directly to the end-face 26 of threaded housing element 28. Threaded housing element 28 may be comprised of a plastic, epoxy-like, or polymer-based material and may be a solid cylindrical element with metal overlay mounting threads 14. Electrical leads 30 and 32 may be embedded within threaded housing element 28 with electrical lead 30 connected to metal overlay mounting threads 14 at connection 34 and electrical lead 32 connected to metal cap 34 at connection 36. In this configuration, during assembly of white light LED device 10, modular insert element 24 may be inserted into encapsulating housing 12 (see FIG. 1A) and secured thereto prior to adhering diffusing surface 22 (again, see FIG. 1A) to encapsulating housing 12 as a final assembly step.

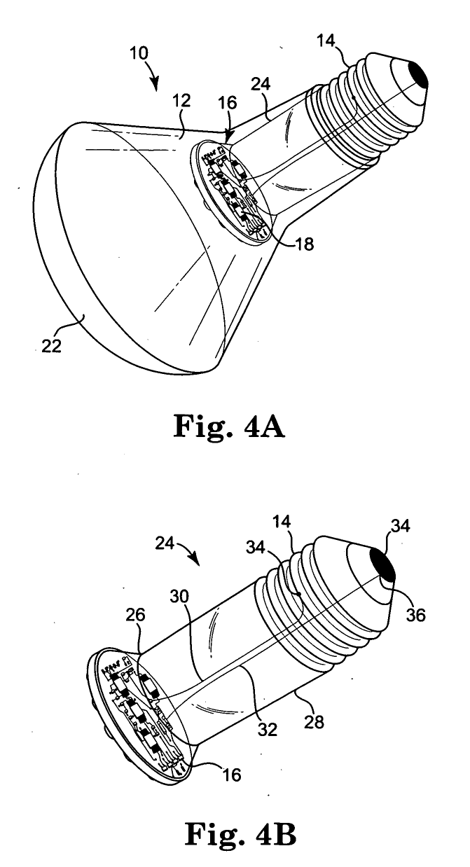

FIG. 4A depicts the “PAR” configuration of a white light LED device 10 in accordance with the present invention highlighting modular insert element 24. The “PAR” series is most easily recognized by the parabolic surface in the region extending from circuit board 16 to diffusing surface 22. Incandescent light bulb devices with the shape and form factor depicted in FIG. 3A have generally been categorized by the American National Standards Institute (ANSI) as having part numbers PAR10, PAR20, and PAR305, the difference being their height, increasing with higher numerical designation. In one embodiment of the present invention, modular insert element 24 shown in FIG. 4B may be substantially equivalent, i.e., interchangeable with, to that shown in FIGS. 2B and 3B thereby allowing the modular insert element 24 to be a common module for both the “R”, “BR”, and “PAR” series devices.

Modular insert element 24, shown separately in FIG. 4B, may have circuit board 16 adhered directly to the end-face 26 of threaded housing element 28. Threaded housing element 28 may be comprised of a plastic, epoxy-like, or polymer-based material and may be a solid cylindrical element with metal overlay mounting threads 14. Electrical leads 30 and 32 may be embedded within threaded housing element 28 with electrical lead 30 connected to metal overlay mounting threads 14 at connection 34 and electrical lead 32 connected to metal cap 34 at connection 36. In this configuration, during assembly of white light LED device 10,modular insert element 24 may be inserted into encapsulating housing 12 and secured thereto prior to adhering diffusing surface 22 to encapsulating housing 12 as a final assembly step.

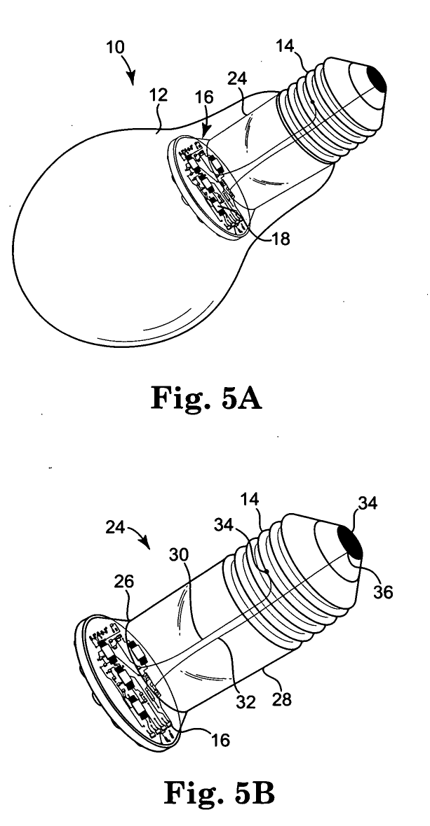

FIG. 5A depicts the “A” configuration of a white light LED device 10 in accordance with the present invention highlighting modular insert element 24. The “A” series is most easily recognized by the nearly round surface in the region extending from circuit board 16. Incandescent light bulb devices with the shape and form factor depicted in FIG. 5A have generally been categorized by the American National Standards Institute (ANSI) as having part numbers AR15, A19; A21 and A23, the difference being their height, increasing with higher numerical designation. In one embodiment of the present invention, modular insert element 24 shown in FIG. 5B may be substantially equivalent, i.e., interchangeable with, to that shown in FIGS. 2B, 3B and 4B thereby allowing the modular insert element 24 to be a common module for both the “R”, “BR”, “PAR” and “A” series devices.

Modular insert element 24, shown separately in FIG. 5B, may have circuit board 16 adhered directly to the end-face 26 of threaded housing element 28. Threaded housing element 28 may be comprised of a plastic, epoxy-like, or polymer-based material and may be a solid cylindrical element with metal overlay mounting threads 14. Electrical leads 30 and 32 may be embedded within threaded housing element 28 with electrical lead 30 connected to metal overlay mounting threads 14 at connection 34 and electrical lead 32 connected to metal cap 34 at connection 36. In this configuration, during assembly of white light LED device 10, modular insert element 24 may be inserted into encapsulating housing 12 and secured thereto prior to as a final assembly step.

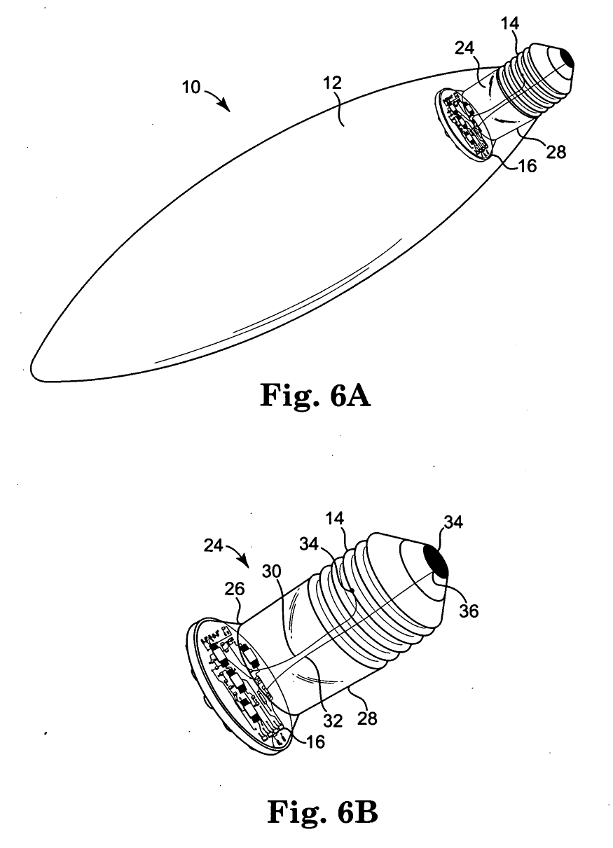

FIG. 6A depicts the “B” configuration of a white light LED device 10 in accordance with the present invention highlighting modular insert element 24. The “B” series is most easily recognized by the tapered surface in the region extending from circuit board 16 to the distal tip of the device. Incandescent light bulb devices with the shape and form factor depicted in FIG. 6A have generally been categorized by the American National Standards Institute (ANSI) as having part numbers B10½, and B13, the difference being their height, increasing with higher numerical designation. In one embodiment of the present invention, modular insert element 24 shown in FIG. 6B, may utilize the same circuit board 16 and associated opto-electronics as depicted in FIGS. 2B through 5B with a reduced physical dimension to the mountings threads 14 (for example, compare FIG. 6B with 5B). In the embodiment depicted in FIG. 6A. encapsulating housing 12 may consist of a frosted or opal like material such that the light emanating from encapsulating housing 12 appears uniformly distributed over the surface with no apparent bright spots.

Modular insert element 24; shown separately in FIG. 6B, may have circuit board 16 adhered directly to the end-face 26 of threaded housing element 28. Threaded housing element 28 may be comprised of a plastic, epoxy-like, or polymer-based material and may be a solid cylindrical element with metal overlay mounting threads 14. Electrical leads 30 and 32 may be embedded within threaded housing element 28 with electrical lead 30 connected to metal overlay mounting threads 14 at connection 34 and electrical lead 32 connected to metal cap 34 at connection 36. In this configuration, during assembly of white light LED device 10, modular insert element 24 may be inserted into encapsulating housing 12 and secured thereto.

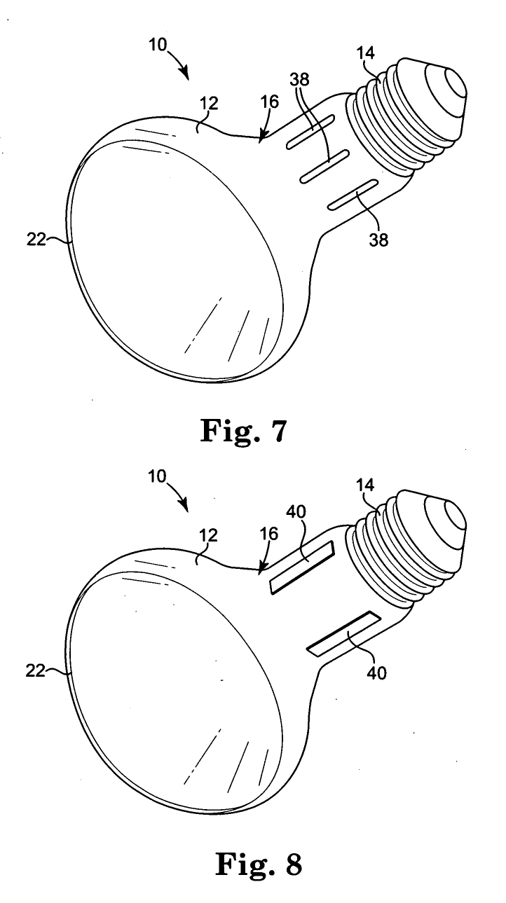

FIG. 7 depicts a white light LED device 10 in accordance with the present invention with a shape and form factor substantially equivalent to the “R” series device shown in FIG. 1A. FIG. 7 shows air vents 38 placed circumferentially around the neck of encapsulating housing 12. Air vents 38 placed in this manner may allow heat generated from within the white light LED device 10 to escape by convection air currents. Although shown specifically in the “R” series shape and form factor, the present invention contemplates the air vents 38 may be incorporated in any of the embodiments described above.

FIG. 8 depicts a white light LED device 10 in accordance with the present invention with a shape and form factor substantially equivalent to the “R” series device shown in FIG. 1A. FIG. 8 shows heat transfer elements 40 placed circumferentially around the neck of encapsulating housing 12. Heat transfer elements 40 placed in this manner may allow heat generated from within the white light LED device 10 to escape by convection air currents. Although shown specifically in the “R” series shape and form factor, the present invention contemplates the heat transfer elements 40 may be incorporated in any of the embodiments described above.

The present invention should not be considered limited to the particular examples described above, but rather should be understood to cover all aspects of the invention as fairly set out in the attached claims. Various modifications to the shape and form factors described above, equivalent processes to supplying the appropriate drive voltages to the LEDs, as well as numerous structures to which the present invention may be applicable will be readily apparent to those of skill in the art to which the present invention is directed upon review of the present specification. One such example is the so-called “vanity lights” generally categorized by the American National Standards Institute (ANSI) as having part numbers G15½, G25, or G40, which are incorporated in the present application by reference thereto. The following claims are intended to cover such modifications and devices.

I claim:

1. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage; and
an encapsulating housing enclosing the solid state light emitters and the activating electronics with a shape and form factor substantially equivalent to the American National Standards Institute (ANSI) R20 lighting device structure.

2. The device of claim 1 wherein the group of solid state emitters comprises a red, green, and blue light emitting diode.

3. The device of claim 1 wherein the encapsulating housing includes a diffusing element on its end face.

4. The device of claim 1 wherein the encapsulating housing includes a reflective element on its inboard surface excluding the end face.

5. The device of claim 1 wherein the encapsulating housing includes air vents.

6. The device of claim 1 wherein the encapsulating housing is in mechanical contact with a heat sinking element.

7. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage; and
an encapsulating housing enclosing the solid state light emitters and the activating electronics with a shape and form factor substantially equivalent to the American National Standards Institute (ANSI) R30 lighting device structure

8. The device of claim 7 wherein the group of solid state emitters comprises a red, green, and blue light emitting diode.

9. The device of claim 7 wherein the encapsulating housing includes a diffusing element on its end face.

10. The device of claim 7 wherein the encapsulating housing includes a reflective element on its inboard surface excluding the end face.

11. The device of claim 7 wherein the encapsulating housing includes air vents.

12. The device of claim 7 wherein the encapsulating housing is in mechanical contact with a heat sinking element.

13. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage; and
an encapsulating housing enclosing the solid state light emitters and the activating electronics with a shape and form factor substantially equivalent to the American National Standards Institute (ANSI) R40 lighting device structure.

14. The device of claim 13 wherein the group of solid state emitters comprises a red, green, and blue light emitting diode.

15. The device of claim 13 wherein the encapsulating housing includes a diffusing element on its end face.

16. The device of claim 13 wherein the encapsulating housing includes a reflective element on its inboard surface excluding the end face.

17. The device of claim 13 wherein the encapsulating housing includes air vents.

18. The device of claim 13 wherein the encapsulating housing is in mechanical contact with a heat sinking element.

19. A lighting device for generating diffuse white light comprising:
a group of solid state light emitters, said group including light emitting diodes energized by a direct current (DC) voltage;
a housing configured to supply a direct current (DC) voltage to the base of the lighting device;
electronics to activate the solid state light emitters, wherein the electronics may be configured as a DC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) R20 lighting device structure.

20. A lighting device for generating diffuse white light comprising:
a group of solid state light emitters, said group including light emitting diodes energized by a direct current (DC) voltage;
a housing configured to supply a direct current (DC) voltage to the base of the lighting device;
electronics to activate the solid state light emitters, wherein the electronics may be configured as a DC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) R30 lighting device structure.

21. A lighting device for generating diffuse white light comprising:
a group of solid state light emitters, said group including light emitting diodes energized by a direct current (DC) voltage;
a housing configured to supply a direct current (DC) voltage to the base of the lighting device;
electronics to activate the solid state light emitters, wherein the electronics may be configured as a DC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) R40 lighting device structure

22. A lighting device for generating diffuse white light comprising:
a group of solid state light emitters, said group including light emitting diodes energized by an alternating current (AC) drive voltage;
a housing configured to supply a 120 volt AC (60 Hertz) input signal to the base of the lighting device;
electronics to activate the solid state light emitters, wherein the electronics may be configured as a AC-to-AC converter to apply the appropriate AC voltage(s) and drive currents to the AC driven LEDs; and
an encapsulating housing enclosing the solid state light emitters and the activating electronics with a shape and form factor substantially equivalent to the American National Standards Institute (ANSI) R20 lighting device structure.

23. A lighting device for generating diffuse white light comprising:
a group of solid state light emitters, said group including light emitting diodes energized by an alternating current (AC) drive voltage;
a housing configured to supply a 120 volt AC (60 Hertz) input signal to the base of the lighting device;
electronics to activate the solid state light emitters, wherein the electronics may be configured as a AC-to-AC converter to apply the appropriate AC voltage(s) and drive currents to the AC driven LEDs; and
an encapsulating housing enclosing the solid state light emitters and the activating electronics with a shape and form factor substantially equivalent to the American National Standards Institute (ANSI) R30 lighting device structure.

24. A lighting device for generating diffuse white light comprising:
a group of solid state light emitters, said group including light emitting diodes energized by an alternating current (AC) drive voltage;
a housing configured to supply a 120 volt AC (60 Hertz) input signal to the base of the lighting device;
electronics to activate the solid state light emitters, wherein the electronics may be configured as a AC-to-AC converter to apply the appropriate AC voltage(s) and drive currents to the AC driven LEDs; and
an encapsulating housing enclosing the solid state light emitters and the activating electronics with a shape and form factor substantially equivalent to the American National Standards Institute (ANSI) R40 lighting device structure.

25. A lighting device for generating diffuse white light comprising:
a first group of solid state light emitters, said first group including light emitting diodes energized by an alternating current (AC) drive voltage;
a second group of solid state light emitters, said second group including light emitting diodes energized by an direct current (DC) drive voltage;
a housing configured to supply a 120 volt AC (60 Hertz) input signal to the base of the lighting device;
electronics to activate the solid state light emitters, wherein one channel of the electronics may be configured as a AC-to-AC converter to apply the appropriate AC voltage(s) and drive currents to the AC driven LEDs;
a second channel of the electronics to activate the solid state light emitters, wherein said second channel of the electronics may be configured as a AC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) R20 lighting device structure.

26. A lighting device for generating diffuse white light comprising:
a first group of solid state light emitters, said first group including light emitting diodes energized by an alternating current (AC) drive voltage;
a second group of solid state light emitters, said second group including light emitting diodes energized by an direct current (DC) drive voltage;
a housing configured to supply a 120 volt AC (60 Hertz) input signal to the base of the lighting device;
electronics to activate the solid state light emitters, wherein one channel of the electronics may be configured as a AC-to-AC converter to apply the appropriate AC voltage(s) and drive currents to the AC driven LEDs;
a second channel of the electronics to activate the solid state light emitters, wherein said second channel of the electronics may be configured as a AC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) R30 lighting device structure.

27. A lighting device for generating diffuse white light comprising:
a first group of solid state light emitters, said first group including light emitting diodes energized by an alternating current (AC) drive voltage;
a second group of solid state light emitters, said second group including light emitting diodes energized by an direct current (DC) drive voltage;
a housing configured to supply a 120 volt AC (60 Hertz) input signal to the base of the lighting device;
electronics to activate the solid state light emitters, wherein one channel of the electronics may be configured as a AC-to-AC converter to apply the appropriate AC voltage(s) and drive currents to the AC driven LEDs;
a second channel of the electronics to activate the solid state light emitters, wherein said second channel of the electronics may be configured as a AC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) R40 lighting device structure.

28. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage; and
an encapsulating housing enclosing the solid state light emitters and the activating electronics with a shape and form factor substantially equivalent to the American National Standards Institute (ANSI) BR25, BR30, or BR40 lighting device structures.

29. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage; and
an encapsulating housing enclosing the solid state light emitters and the activating electronics with a shape and form factor substantially equivalent to the American National Standards Institute (ANSI) PAR15, PAR 20, or PAR305 lighting device structures.

30. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage; and
an encapsulating housing enclosing the solid state light emitters and the activating electronics with a shape and form factor substantially equivalent to the American National Standards Institute (ANSI) A15, A19, A21 or A23 lighting device structures.

31. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage; and
an encapsulating housing enclosing the solid state light emitters and the activating electronics with a shape and form factor substantially equivalent to the American National Standards Institute (ANSI) B10½ or B13 lighting device structures.

32. A lighting device for generating diffuse white light comprising:
a group of solid state light emitters, said group including light emitting diodes energized by a direct current (DC) voltage;
a housing configured to supply a direct current (DC) voltage to the base of the lighting device;
electronics to activate the solid state light emitters, wherein the electronics may be configured as a DC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) BR25, BR30, or BR40 lighting device structures.

33. A lighting device for generating diffuse white light comprising:
a group of solid state light emitters, said group including light emitting diodes energized by a direct current (DC) voltage;
a housing configured to supply a direct current (DC) voltage to the base of the lighting device;
electronics to activate the solid state light emitters, wherein the electronics may be configured as a DC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) PAR15, PAR20, or PAR305 lighting device structures.

34. A lighting device for generating diffuse white light comprising:
a group of solid state light emitters, said group including light emitting diodes energized by a direct current (DC) voltage;
a housing configured to supply a direct current (DC) voltage to the base of the lighting device;
electronics to activate the solid state light emitters, wherein the electronics may be configured as a DC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) A15, A19, A21 or A23 lighting device structures.

35. A lighting device for generating diffuse white light comprising:
a group of solid state light emitters, said group including light emitting diodes energized by a direct current (DC) voltage;
a housing configured to supply a direct current (DC) voltage to the base of the lighting device;
electronics to activate the solid state light emitters, wherein the electronics may be configured as a DC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) B10½ or B13 lighting device structures.

36. A lighting device for generating diffuse white light comprising:
a group of solid state light emitters, said group including light emitting diodes energized by an alternating current (AC) drive voltage;
a housing configured to supply a 120 volt AC (60 Hertz) input signal to the base of the lighting device;
electronics to activate the solid state light emitters, wherein the electronics may be configured as a AC-to-AC converter to apply the appropriate AC voltage(s) and drive currents to the AC driven LEDs; and
an encapsulating housing enclosing the solid state light emitters and the activating electronics with a shape and form factor substantially equivalent to the American National Standards Institute (ANSI) BR25, BR30, or BR40 lighting device structures.

37. A lighting device for generating diffuse white light comprising:
a group of solid state light emitters, said group including light emitting diodes energized by an alternating current (AC) drive voltage;
a housing configured to supply a 120 volt AC (60 Hertz) input signal to the base of the lighting device;
electronics to activate the solid state light emitters, wherein the electronics may be configured as a AC-to-AC converter to apply the appropriate AC voltage(s) and drive currents to the AC driven LEDs; and
an encapsulating housing enclosing the solid state light emitters and the activating electronics with a shape and form factor substantially equivalent to the American National Standards Institute (ANSI) PAR15, PAR 20, or PAR305 lighting device structures.

38. A lighting device for generating diffuse white light comprising:
a group of solid state light emitters, said group including light emitting diodes energized by an alternating current (AC) drive voltage;
a housing configured to supply a 120 volt AC (60 Hertz) input signal to the base of the lighting device;
electronics to activate the solid state light emitters, wherein the electronics may be configured as a AC-to-AC converter to apply the appropriate AC voltage(s) and drive currents to the AC driven LEDs; and
an encapsulating housing enclosing the solid state light emitters and the activating electronics with a shape and form factor substantially equivalent to the American National Standards Institute (ANSI) A15, A19, A21 or A23 lighting device structures.

39. A lighting device for generating diffuse white light comprising:
a group of solid state light emitters, said group including light emitting diodes energized by an alternating current (AC) drive voltage;
a housing configured to supply a 120 volt AC (60 Hertz) input signal to the base of the lighting device;
electronics to activate the solid state light emitters, wherein the electronics may be configured as a AC-to-AC converter to apply the appropriate AC voltage(s) and drive currents to the AC driven LEDs; and
an encapsulating housing enclosing the solid state light emitters and the activating electronics with a shape and form factor substantially equivalent to the American National Standards Institute (ANSI) B10½ or B13 lighting device structures.

40. A lighting device for generating diffuse white light comprising:
a first group of solid state light emitters, said first group including light emitting diodes energized by an alternating current (AC) drive voltage;
a second group of solid state light emitters, said second group including light emitting diodes energized by an direct current (DC) drive voltage;
a housing configured to supply a 120 volt AC (60 Hertz) input signal to the base of the lighting device;
electronics to activate the solid state light emitters, wherein one channel of the electronics may be configured as a AC-to-AC converter to apply the appropriate AC voltage(s) and drive currents to the AC driven LEDs;
a second channel of the electronics to activate the solid state light emitters, wherein said second channel of the electronics may be configured as a AC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) BR25, BR30, or BR40 lighting device structures.

41. A lighting device for generating diffuse white light comprising:
a first group of solid state light emitters, said first group including light emitting diodes energized by an alternating current (AC) drive voltage;
a second group of solid state light emitters, said second group including light emitting diodes energized by an direct current (DC) drive voltage;
a housing configured to supply a 120 volt AC (60 Hertz) input signal to the base of the lighting device;
electronics to activate the solid state light emitters, wherein one channel of the electronics may be configured as a AC-to-AC converter to apply the appropriate AC voltage(s) and drive currents to the AC driven LEDs;
a second channel of the electronics to activate the solid state light emitters, wherein said second channel of the electronics may be configured as a AC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) PAR15, PAR 20, or PAR305 lighting device structures.

42. A lighting device for generating diffuse white light comprising:
a first group of solid state light emitters, said first group including light emitting diodes energized by an alternating current (AC) drive voltage;
a second group of solid state light emitters, said second group including light emitting diodes energized by an direct current (DC) drive voltage;
a housing configured to supply a 120 volt AC (60 Hertz) input signal to the base of the lighting device;
electronics to activate the solid state light emitters, wherein one channel of the electronics may be configured as a AC-to-AC converter to apply the appropriate AC voltage(s) and drive currents to the AC driven LEDs;
a second channel of the electronics to activate the solid state light emitters, wherein said second channel of the electronics may be configured as a AC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) A15, A19, A21 or A23 lighting device structures.

43. A lighting device for generating diffuse white light comprising:
a first group of solid state light emitters, said first group including light emitting diodes energized by an alternating current (AC) drive voltage;
a second group of solid state light emitters, said second group including light emitting diodes energized by an direct current (DC) drive voltage;
a housing configured to supply a 120 volt AC (60 Hertz) input signal to the base of the lighting device;
electronics to activate the solid state light emitters, wherein one channel of the electronics may be configured as a AC-to-AC converter to apply the appropriate AC voltage(s) and drive currents to the AC driven LEDs;
a second channel of the electronics to activate the solid state light emitters, wherein said second channel of the electronics may be configured as a AC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) B10½ or B13 lighting device structures.

44. A modular insert device for insertion into a light encapsulating housing comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage;
a circuit board to attach and connect said solid state light emitters and said electronics;
a diffusing element attached to said circuit board interposed between the solid state light emitters and said encapsulating housing;
a threaded housing with metal overlay mounting threads and an end-face metal cap on its' distal end and said electronics on its' opposing end;
a first electrical lead connecting said electronics to said metal overlay mounting threads, and
a second electrical lead connecting said electronics to said end-face metal cap.

45. The device of claim 44 wherein the diffusing element is attached directly to the solid state light emitters.

46. The device of claim 44 wherein the diffusing element is a lens.

47. The device of claim 46 wherein the lens has a negative focal length.

48. The device of claim 44 wherein the diffusing element is comprised of an opal-like material.

49. A modular insert device for insertion into a light encapsulating housing comprising:
a group of solid state light emitters, said group including light emitting diodes energized by a direct current (DC) voltage;
a housing configured to supply a direct current (DC) voltage to the base of the lighting device;
electronics to activate the solid state light emitters, wherein the electronics may be configured as a DC-to-DC converter to apply the appropriate DC voltage(s) and drive currents to the DC driven LEDs;
a circuit board to attach and connect said solid state light emitters and said electronics;
a diffusing element attached to said circuit board interposed between the solid state light emitters and said encapsulating housing;
a threaded housing with metal overlay mounting threads and an end-face metal cap on its' distal end and said electronics on its' opposing end;
a first electrical lead connecting said electronics to said metal overlay mounting threads, and
a second electrical lead connecting said electronics to said end-face metal cap.

50. The device of claim 49 wherein the diffusing element is attached directly to the solid state light emitters.

51. The device of claim 49 wherein the diffusing element is a lens.

52. The device of claim 51 wherein the lens has a negative focal length.

53. The device of claim 49 wherein the diffusing element is comprised of an opal-like material.

54. A modular insert device for insertion into a light encapsulating housing comprising:
a group of solid state light emitters, said group including light emitting diodes energized by an alternating current (AC) drive voltage;
a housing configured to supply a 120 volt AC (60 Hertz) input signal to the base of the lighting device;
electronics to activate the solid state light emitters, wherein the electronics may be configured as a AC-to-AC converter to apply the appropriate AC voltage(s) and drive currents to the AC driven LEDs;
a circuit board to attach and connect said solid state light emitters and said electronics;
a diffusing element attached to said circuit board interposed between the solid state light emitters and said encapsulating housing;
a threaded housing with metal overlay mounting threads and an end-face metal cap on its' distal end and said electronics on its' opposing end;
a first electrical lead connecting said electronics to said metal overlay mounting threads, and
a second electrical lead connecting said electronics to said end-face metal cap.

55. The device of claim 54 wherein the diffusing element is attached directly to the solid state light emitters.

56. The device of claim 54 wherein the diffusing element is a lens.

57. The device of claim 56 wherein the lens has a negative focal length.

58. The device of claim 54 wherein the diffusing element is comprised of an opal-like material.

59. A modular insert device for insertion into a light encapsulating housing comprising:
a first group of solid state light emitters, said first group including light emitting diodes energized by an alternating current (AC) drive voltage;
a second group of solid state light emitters, said second group including light emitting diodes energized by an direct current (DC) drive voltage;
a housing configured to supply a 120 volt AC (60 Hertz) input signal to the base of the lighting device;
electronics to activate the solid state light emitters, wherein one channel of the electronics may be configured as a AC-to-AC converter to apply the appropriate AC voltage(s) and drive currents to the AC driven LEDs;
a second channel of the electronics to activate the solid state light emitters, wherein said second channel of the electronics may be configured as a AC-to-DC converter to apply the appropriate DC voltage(s) and drive currents to the DC driven LEDs;
a circuit board to attach and connect said solid state light emitters and said electronics;
a diffusing element attached to said circuit board interposed between the solid state light emitters and said encapsulating housing;
a threaded housing with metal overlay mounting threads and an end-face metal cap on its' distal end and said electronics on its' opposing end;
a first electrical lead connecting said electronics to said metal overlay mounting threads, and
a second electrical lead connecting said electronics to said end-face metal cap.

60. The device of claim 59 wherein the diffusing element is attached directly to the solid state light emitters.

61. The device of claim 59 wherein the diffusing element is a lens.

62. The device of claim 61 wherein the lens has a negative focal length.

63. The device of claim 59 wherein the diffusing element is comprised of an opal-like material.

64. A lighting device for generating diffuse white light comprising:
a group of solid state light emitters, said group including light emitting diodes energized by a direct current (DC) voltage;
electronics to activate the solid state light emitters, wherein the electronics converts 120 volt 60 cycles per second alternating current to a steady state direct current (DC) voltage; and
an encapsulating housing enclosing the solid state light emitters and the activating electronics with a shape and form factor substantially equivalent to the American National Standards Institute (ANSI) G15½, G25, or G40 lighting device structure.

65. A lighting device for generating diffuse white light comprising:
a group of solid state light emitters, said group including light emitting diodes energized by a direct current (DC) voltage;
a housing configured to supply a direct current (DC) voltage to the base of the lighting device;
electronics to activate the solid state light emitters, wherein the electronics may be configured as a DC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) G15½, G25, or G40 lighting device structure.

66. A lighting device for generating diffuse white light comprising:
a group of solid state light emitters, said group including light emitting diodes energized by an alternating current (AC) drive voltage;
a housing configured to supply a 120 volt AC (60 Hertz) input signal to the base of the lighting device;
electronics to activate the solid state light emitters, wherein the electronics may be configured as a AC-to-AC converter to apply the appropriate AC voltage(s) and drive currents to the AC driven LEDs; and
an encapsulating housing enclosing the solid state light emitters and the activating electronics with a shape and form factor substantially equivalent to the American National Standards Institute (ANSI) G15½, G25, or G40 lighting device structure.

67. A lighting device for generating diffuse white light comprising:
a first group of solid state light emitters, said first group including light emitting diodes energized by an alternating current (AC) drive voltage;
a second group of solid state light emitters, said second group including light emitting diodes energized by an direct current (DC) drive voltage;
a housing configured to supply a 120 volt AC (60 Hertz) input signal to the base of the lighting device;
electronics to activate the solid state light emitters, wherein one channel of the electronics may be configured as a AC-to-AC converter to apply the appropriate AC voltage(s) and drive currents to the AC driven LEDs;
a second channel of the electronics to activate the solid state light emitters, wherein said second channel of the electronics may be configured as a AC-to-DC converter to apply the appropriate DC voltage(s) and drive currents to the DC driven LEDs; and
an encapsulating housing enclosing the solid state light emitters and the activating electronics with a shape and form factor substantially equivalent to the American National Standards Institute (ANSI) G15½, G25, or G40 lighting device structure.
